(19) United States
(12) Patent Application Publication
(10) Pub. No.: US 2018/0024378 A1
(43) Pub. Date: Jan. 25, 2018

(54) VARIABLE FOCUS ADHESIVE SPECTACLE LENSES

(71) Applicants: Don Kreiss, Los Angeles, CA (US); Bernard Jackson, Wallingford, CT (US); Shani Burton Johnson, Milwaukee, WI (US); Annie Kerman, Brooklyn, NY (US)

(72) Inventors: Don Kreiss, Los Angeles, CA (US); Bernard Jackson, Wallingford, CT (US); Shani Burton Johnson, Milwaukee, WI (US); Annie Kerman, Brooklyn, NY (US)

(21) Appl. No.: 15/657,060

(22) Filed: Jul. 21, 2017

Related U.S. Application Data
(60) Provisional application No. 62/365,186, filed on Jul. 21, 2016.

(51) Int. Cl. G02C 7/02

(52) U.S. Cl. CPC G02C 7/022

(57) ABSTRACT

A lens apparatus for correcting vision or for magnifying, of a base lens, with first predetermined optical properties; and of at least one adhesive optical decal lens, each with its own predetermined optical properties; where the at least one adhesive optical decal lens may be attached to the base lens forming the lens apparatus; where the lens apparatus may have a third predetermined optical properties. The third predetermined optical properties may provide vision correction according to a prescription. The at least one adhesive optical decal lens and/or the base lens may be manufactured by embossing, and/or die cutting (stamping), yielding effective optical corrective and/or magnifying lenses quickly, easily, and cost effectively as compared against the labor intensive, time consuming, and expensive injection molding, grinding, and polishing processes presently used. Additionally, such adhesive optical decal lenses and methods may be used to extend the useful life of preexisting eyewear.

### PRIORITY NOTICE

The present application claims priority under 35 U.S.C. §119(e) to U.S. Provisional Patent Application Ser. No. 62,365,186 filed on Jul. 21, 2016, the disclosure of which is incorporated herein by reference in its entirety.

### TECHNICAL FIELD OF THE INVENTION

The present invention relates in general to lenses of eyewear and more specifically to optically corrective or magnifying decals for attachment to eyewear yielding a multilayered overall lens apparatus with predetermined corrective or magnifying properties.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Eyesight is currently enhanced by a number of refraction corrective techniques, devices, and apparatuses. Heretofore eyeglass lenses are primarily made via plastic injection molding of impact resistant polycarbonate materials of various thicknesses, that are thicker than a film. The final shape and refractive corrective properties of the end product lens may be finalized through laborious fine grinding techniques that are conducted in specialized laboratories by highly trained specialists. Lens blanks of varying optical power shaped through the plastic injection molding process are provided to these laboratories that approximate the oculus dexter and oculous sinister spherical equivalent power of a lens prescription. Since each eye may require a slightly different corrective solution, lens blanks are fixed at various common spherical equivalent power values predetermined by lens' manufacturers and chosen by analyzing consumer commonalities derived from years of patient eyewear needs. These values are set within the corrective lens industry based on historical data derived by optometrists and ophthalmologists providing prescriptions and requests for lenses. These fixed value settings are then used to create molds of fixed spherical equivalent power for plastic injection molding, to yield the lens blanks. Such lens blanks derived using this manufacturing method are then provided for final processing, to a given lens prescription, which may include grinding processes to eyeglass resellers and lens grinding businesses.

Embodiments of the instant invention provides a method to create optical lenses featuring a range of −6 to +6 diopter an optical spherical equivalent power of +4 diopter can be designed while still maintaining a thin lens profile. Embodiments of the present invention may include adhesive lens decals that may be made permanent or repositionable (removable) with respect to a base or foundation lens of given eyewear, such as eyeglasses.

A typical lens finalization process of the prior art, after the plastic injection molding phase creates the lens blanks, is described below. The following procedure assumes the final plastic lenses are being final processed at an optical laboratory or the like.

Step 1: An optical laboratory technician inputs the optical prescription for a pair of plastic lenses in the laboratory's computer. The computer then provides a printout specifying more information necessary for producing the required prescription.

Step 2: Based on this information (determined by the optical prescription), the technician selects the appropriate plastic lens blanks. Each lens blank is placed in a prescription tray along with the customer's desired eyeglass frames and an original work order. The prescription tray may remain with the technician throughout these final production processes.

When appropriate curves may have already been ground into a front of the lens blank, the technician must still grind curves into the back (rear) of the lens blank. This may be done in a curve generator. After polishing the lenses, the lenses may be put in an edge grinder, which grinds each lens to its proper shape and places a bevel around the edge so that the lens will fit the desired eyeglass frames. Following any necessary tint applications, the lenses are put into the frames.

Typically, plastic lens blanks have different curves already ground into the front of the plastic lens blank; therefore, the technician must select the plastic lens blank that corresponds to the optical prescription required for each lens. The rest of the optical prescription, or power, must be ground into the back (rear) of the lens.

Blocking—The technician places the plastic lens blanks in a lensometer, an instrument used to locate and mark the “optical center”—the point that should be centered over the customer's pupil—of the lens blanks. Next, protective removable adhesive tape is affixed to the front of each lens blank to keep the front from being scratched during the “blocking” process. The technician then places one lens blank at a time in a “blocker” machine, which contains a heated lead alloy that fuses the block to the front of the lens blank. The blocks are used to hold each lens in place during the grinding and polishing processes.

Next, the technician places each lens blank into a generator, a grinding machine, that is set for the optical prescription. The generator grinds the appropriate optical curves into the back of each lens. After this step, the lenses must be “fined,” or polished.

The technician selects a metal lens lap—a mold corresponding to the required optical prescription of the lens, and both lenses are placed in the fining machine with the back of each lens in the appropriate lap. The front of each lens is then polished in a series of fining operations. First, each lens is rubbed against an abrasive fining pad made of soft sandpaper. After a second fining pad made of a smooth plastic is placed over the original sandpaper pad, the lens is polished again, as the fining machine rotates the pads in a circular motion while water flows over the lenses. After the initial fining process is completed, the two pads are peeled off.

Next, the laps are removed from each lens and soaked in hot water for a few moments. The laps are then attached back on the lenses and placed in the fining machine, where the third and final fining pad is attached. The fining machine rotates the pads in a circular motion while a polishing compound consisting of aluminum oxide, water, and polymers flows over the lenses.

The lenses are removed from the fining machine, and the block attached to each lens is gently detached with a small hammer. Then, the protective adhesive tape is removed from each lens, often by hand. The laps are sterilized before they are used to hold other lenses.

Each lens may be marked “L” or “R” with a red grease pencil, indicating which is the left and right lens for the eyewear frame. After the lenses are again placed in the lensometer to check and mark the optical center and inspect the other curves necessary for the proper optical prescription, a leap pad—a small, round metal holder—is then affixed to the back of each lens.

Beveling—Next, the technician selects the lens pattern that matches the shape of the particular eyeglass frames and inserts the pattern and the lenses into an edging machine. The edging machine grinds each lens to its proper shape and places a bevel around the edge of the lens so that the lens will fit the particular eyeglass frames. Water flows over the lens throughout this process. If the lenses require additional grinding, the process is done by hand using a mounted power grinder. This step is necessary for lenses to be inserted in metal or rimless eyeglass frames, which require more precise bevels.

Finally, the lenses may be dipped into a desired treatment or tint container. After drying, the eyeglass lenses are ready for insertion in the desired frames. The optical laboratory may send the lenses back to the optical outlet without the eyeglass frames, in which case the optical outlet will insert the lenses in the eyeglass frames.

Thus, the prior art processes of yield corrective lenses for eyewear is a labor intensive, time consuming, and relatively expensive process.

As people get older, e.g., often around age forty five and older the human lens in the human eye becomes incapable of sufficient accommodation to focus on near objects. This condition is called presbyopia. Continued degradation of vision as humans age, typically means one's optical prescription continue to change over time; which in turn requires the use of multiple corrective glasses that can usually add about three diopters to the optical power of the eyeglasses or contact lenses used. This can become an expensive investment in multiple pairs of glasses with older glasses simply becoming obsolete. The cost of making a lens to a prescription value obtained from an optometrist or ophthalmologist can become prohibitive to older retired individual or individuals from third world countries. Or may cause people to put off getting updated corrective eyewear. The process of plastic injection molding of lens blanks that are then further processed, as aforementioned, is labor intensive, time consuming, relatively expensive, and requires multiple steps that are usually undertaken by laboratories that supply eyeglass frame retailers.

In U.S. Pat. No. 5,138,494, issued to Stephen Kurtin and in U.S. Pat. No. 6,040,947, also issued to Stephen Kurtin, a variable focus liquid filled spectacle lens is described that is purported to solve some of the cost constraints that are associated with traditional lens manufacturing as discussed above. The issues surrounding the use of variable focus lenses at first glance seem appealing in that they can be customized to the individual focus required by the user at the time of use. For reading one focal setting can be obtained by adjusting the amount of fluid pressure within a lens chamber created with two separate substrates surrounding a flexible membrane. At least some prior art patents may address this category of liquid filled variable focus lenses. But even in this form of lens the substrate that comprises the actual outward part of the “lens” sandwich is still plastic injection molded and then assembled into a lens unit. And much of the manufacturing cost is transferred to the frame mechanism construction and overall spectacle assembly process. A typical manufacturer of high end eyeglass wear using the described method is retailing for twelve hundred dollars, which is obviously out of reach of a majority of consumers and medical insurance providers.

In these types of liquid filled variable focus lenses, circular lens construction is essential to avoid optical distortion. This is a limitation of this category of prior art. If the lenses are made to style considerations, then issues arise as the plethora of eyeglass frames in current use worldwide is too numerous to accommodate only circular lenses.

Variable focus spectacles of the prior art attempt to provide the wearer the ability to vary focal optical power through a range of diopter values. Usually from −4 diopter to +4 diopter focal optical power by the turning of a knob or other mechanical device that distorts a floating flexible membrane within a fluid in one iteration or by moving the position of two or more lenses in relation to each other. Both methods are expensive to manufacture and are unsightly and non-stylish to wear.

This is why neither such prior method has actually been adopted by the general spectacle wearer, nor in general by the industry. It is one of the objects of this invention to provide the spectacle wearer a new more stylish alternative to current variable focus lenses while still providing the efficiencies and lens quality that currently exists in the marketplace.

Embodiments, of the present invention addresses such prior art limitations in a series of novel methods and end use optical decals that use currently existing embossing and other material shaping technology to replace the need for plastic injection molding of the rigid lens blanks combined with novel methods that reduce the cost and number of steps required to create corrective and magnifying glasses. Some embodiments of the present invention, solve the limitations provided by U.S. Pat. 6,040,947 and U.S. Pat. 5,138.494 and other prior art variable focus lenses, wherein circular eyeglass frames and lenses are required for proper membrane controlled (bulge) distortion. Some embodiments of the present invention may use microcups, such as currently in use in electrophoretic displays, to solve the limitations associated with liquid filled circular variable focus lenses. Embodiments of the present invention and further objects will become evident to those skilled in the art after reading the following specification together with the attached drawings.

There is a need in the art for improved corrective lens manufacturing; simpler and more cost effective ways to address the problem of vision degradation over time versus current variable focus spectacles; and where these solutions may be implemented in a wide variety of shapes to accommodate the given wearer's fashion and aesthetic needs.

It is to these ends that the present invention has been developed.

### BRIEF SUMMARY OF THE INVENTION

In some embodiments, a system for correcting vision may comprise a gel or liquid filled micro or macro multi-layered embossed, adhesive decal lens apparatus; wherein each such lens may comprise at least one such adhesive optical decal. Using high speed web-rotary embossing technology or other film (e.g., thin film) shaping method, embodiments of the present invention may simplify the manufacturing of magnifying or corrective lenses. In some embodiments, a high impact polycarbonate roll (i.e., the film) may be embossed with macro or micro circular (or other predetermined shape) concave or convex indentations that can be fixed at differing spherical controlled distortions. This is possible due to the thin film cross section of the plastic based substrates employed. In some embodiments, the multi-layered embossed, adhesive decal lens apparatus may be constructed via multi-layering of variously shaped thin film components that when assembled work in tandem, providing a substantially similar optical functionality as prior art lenses. Yet embodiments, may provide larger surface areas to be viewable to the user while creating a plethora of manufacturing efficiencies disclosed herein.

In some embodiments, an intermediate gel or liquid layer may be sandwiched between a plano, magnifying, or corrective similarly embossed flexible plastic substrate and the embossed macro or micro lens, creating one fixed lens unit or apparatus. This apparatus can be finely adjusted for optical power settings by the end user from the amount of gel or liquid or type of gel or liquid used to change the refractive properties of the overall apparatus. Using the refractive index of various liquids, plastics and other transparent materials, adhesive decal lenses may be designed to provide the full spectrum of corrective or magnifying lenses. This apparatus is then lined with non-refractive adhesive that culminates in the adhesive decal lens, with predetermined or variable magnifying or refraction corrective properties to measured spherocylindrical (corrective or magnifying) prescription values.

Through the use of high speed web-die cutting technology each adhesive decal lens may be shaped to any currently available eyeglass design; as well as any closed two dimensional shape. Some embodiments, may provide the ability to hand cut the lens to any desired closed two dimensional shape; thereby uniquely providing customization opportunities.

In some embodiments, an array of micro embossed lenses are provided to create adjustable liquid filled spectacles that can be designed to predetermined shapes and/or sizes. This embodiment solves the issues related to prior art limitations requiring circular eyeglass designs for adjustable/variable focus spectacles.

In some embodiments, corrective or magnifying decals may be adhered to existing corrective or magnifying spectacle lenses to extend the use of those existing spectacles even though the wearer's vision may have degraded beyond the ability of the spectacles to correct without the optical decals.

Optical adhesive lens and apparatus comprising one or more of such optical adhesive lens, may make use of thickness provided by existing spectacle lenses and determination of optical properties may make use of formulas derived from U.S. Pat. No. 3,507,565 to Alvarez and U.S. Pat. No. 7,325,922 to Spivey. Some embodiments, may further employ techniques derived from U.S. Pat. No. 6,040,947 to Kurtin and U.S. Pat. No. 6,930,818 to Rong-Chang Liang.

It is an objective of the present invention to provide an alternative manufacturing method for generating lens apparatus as compared against current manufacturing techniques.

It is another objective of the present invention to provide an improved lens apparatus manufacturing method that may make adhesive optical decal lenses from thin films, such as polycarbonate rolls, with predetermined optical properties, utilizing high speed embossing and/or die cutting techniques.

It is yet another objective of the present invention to provide adhesive optical decal lenses which may be used to retrofit preexisting eyewear to yield eyewear with different and predetermined optical properties, which may extend a useful life of such preexisting eyewear.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Note, in general reference numerals in the accompanying drawings are not unique. For example, each figure may have a reference numeral 1 that may refer to a different structure in each different figure.

FIG. 1A is a top view of an embossing receiving plate, with a thin film polycarbonate transparent sheet or roll; wherein embossing roller 2 is rolling over a surface 1 of the plate and of the thin film, yielding embossed indented 5 adhesive optical decal lens.

FIG. 1B is a cross-section side view of FIG. 1A, showing indentations 5 of the adhesive optical decal lens.

FIG. 2 is a side schematic view of a final lens apparatus 20; wherein the final lens apparatus 20 may comprise a front adhesive optical decal lens 1, a base/foundation lens 5, and a rear adhesive optical decal lens 2.

FIG. 3 may show final lens apparatus 20 of FIG. 2 with an added eyeglass frame depiction, to illustrate the embossing process of FIG. 1, may yield a shape of final lens apparatus 20, that is shaped to fit the eyeglass frame upon embossing.

FIG. 4 may show an exploded view of a final lens apparatus, that for the lens base/foundation may utilized preexisting lenses 2; wherein a front adhesive optical decal lens 1 may be attached to a front face of preexisting lens 2; wherein a rear adhesive optical decal lens 3 may be attached to a rear face of preexisting lens 2; and wherein smaller adhesive optical decal lens 5 may be attached to preexisting lens 2 to generate a bi-focal or magnifying configuration for the final lens apparatus.

FIG. 5 may show a final lens apparatus embodiment, utilizing preexisting eyeglasses, with preexisting lens 6, with adhesive optical decal lens 2 attached to preexisting lens 6, and with smaller adhesive optical decal lens 1 and/or smaller adhesive optical decal lens 3 attached to adhesive optical decal lens 2.

FIG. 6 (1)(3)(7)(11)(15) show a side view of various thin layer iterations of the lens curvatures disclosed in U.S. Pat. No. 3,507,565. Embodiments of the present invention may provide for thinner lens profiles, with base lenses providing the required additional refraction thickness through additive build-up of varied lens configurations that comprise the final combined refractive properties of the final lens apparatus disclosed herein.

FIG. 8 (10)(1)(7)(8) show a side view of a lens apparatus designed using the techniques disclosed by U.S. Pat. No. 3,507,565 with the novel thin film additive decal system of the instant invention.

FIG. 9 (1)(3)(10)(9)(11)(6)(7)(8) shows the corrective or magnifying lens disclosed in U.S. Pat. No. 6,040,947 as embodied in the present invention. The flexible membrane is positioned in a fixed state and then a decal is created that is larger than the eyewear base lens. Then a front facing sub-lens apparatus and a rear face sub-lens apparatus is attached to a base lens apparatus wherein the combined refractive indexes of all three units create one optical focal value. This embodiment provides a thinner eyewear profile and allows for re-application of differing optical power values as the wearer's eyesight degrades.

FIG. 10 may show sub-lens decal assemblies 13, 16, 11, and 10 as they would interlay with the base lens 2 and base lens 14 of an eyeglass or spectacle frame 5.

### DETAILED DESCRIPTION OF THE INVENTION

The present invention is directed to eyewear, such as, but not limited to, eyeglasses, reading glasses, sunglasses, goggles, protective eyewear, helmets with eyewear, and/or the like. Some embodiments may provide corrective focus and/or magnifying properties to plano lenses of a variety of shapes, sizes, and/or types. Some embodiments may correct degradation of focus in existing patient eyewear without the need to replace the existing patient eyewear; by affixing adhesive optical decal(s) to the existing patient eyewear, with particular optical properties of the adhesive optical decal, that results in an overall apparatus with corrected optical properties. Using adhesive or other bonding techniques a plano lens may be transformed into a corrective or magnifying lens through the use of adhesive optical decal(s) with predetermined optical properties. Additionally existing corrective or magnifying lenses may be transformed into different optical power lenses simply by adhering the adhesive optical decal(s) to the front and/or to the back (rear) of the existing spectacle lenses.

Some embodiments, provide for high speed manufacturing of low cost, yet effective and durable, magnifying and corrective adhesive optical decal lenses. For example, and without limiting the scope of the present invention, such high speed manufacturing techniques may utilize high speed web-rotary embossing technology and/or web-die cutting technology.

Using optical formulas from the prior art describing lens thickness and refractive index of certain materials and liquids, embodiments of the present invention may employ an additive and/or subtractive multi-layered method to create a final apparatus, with predetermined refractive and/or optical properties. Adhesive optical decal lens, with predetermined refractive and/or optical properties may be adhered to plano or to magnifying or corrective preexisting lenses of sunglasses, safety glasses, or other objects where corrective or magnification of indicia is required or desired. The refractive and/or optical properties of a given adhesive optical decal may differ from the refractive and/or optical properties of the final apparatus. The final apparatus may comprise one or more of the adhesive optical decal lens. The final apparatus may comprise at least one plano or at least one preexisting lens. In some embodiments, adhesive optical decal lens may be attached to a front and/or to a rear of the plano or the preexisting lens. In some embodiments, adhesive optical decal lens may be attached to other adhesive optical decal lens.

Some embodiments may provide that shaping of a front or outer face of a lens base/foundation (e.g., the plano or the preexisting lens) may be made to a minimum thickness value and additional refraction needed for the finished lens may be provided by either addition of layers of shaped materials, gels, liquids or other substrates whether liquid or solid. By limiting the thickness required for the front or outer face of the lens base/foundation, many material shaping methods may be employed to accurately provide the end result curvature required to create optical spherocylindrical (corrective or magnifying) prescription values in the overall lens apparatus; and without the need of plastic injection molding processes or grinding and other such finishing processes as previously described.

Lens thickness profile formulas from U.S. Pat. No. 7,325,922 B2 to Spivey, which refers to U.S. Pat. No. 3,507,565 to Alvarez, provide basic general equations defining the lens thickness profile, such as:

((av+1)⁻²a³t/au³+a(av+1)⁻¹a²t/avau)1_{(u,vF(o,o)}˜2A [1]

(d³t/av²au)1_{(u,v)˜(O,O)}˜2A [2]

((av+1)⁻¹a³t/avau²−a(av+1)⁻²d²t/du²)1_{(u,v)˜(o,o)}=0 [3]

The notation “(u,v)=(O,O)” may indicate that the relations only hold for the center point (u,v)=(O,O), but not necessarily outside of that point. However, prior art applicant required the lens thickness profile functions to be continuous, and the derivatives up to at least a third order to be continuous. Prior art Applicant picks A for one lens to be the complement (negative value) of A for the other lens.

The solutions to these equations may be:

t=A[uv2+2(av+1)(au−sin(au))/a³]+B[2(av+1)(1−cos(au))Ia²)]+C[v sin(au)/a−(au sin(au))/a²)]+Du+E+F(v)+F1(u, v)u⁴+F2(v)u³v+F3(v)u²v²+F4(v)uv³ [4]

where, F(v), F1(u,v), F2(v), F3(v), F4(v) may be functions over the area of the lenses for which derivatives up to at least third order may be continuous.

For Translation Only Designs:

In the case of translation only designs, a=O. Prior art Applicant has defined x=u, and y=v. He defines the origin x=O, y=O to be the point directly in front of the pupil when looking straight ahead. The equations in this form for the translation designs may be:

(d³t/dx³)1_{(x,y)=(0,0)}+2A [5]

(d³t/dxdy²)1_{(x,y)=(0,0)}=2A [6]

and

(d³t/dx²dy)1_{(x,y)=(0,0)}=0 [7]

Note that the Alvarez (U.S. Pat. No. 3,507,565) description may be the same at the center (x,y)=(O,O), but Alvarez also applies this restriction away from the center point; whereas, embodiments of the present invention may consider a wider variety of parameters to optimize the design across the entire lens profile. As above prior art Applicant picks A for one lens to be the complement of A for the other lens.

A solution may be found by taking the limit as a˜o in the above thickness expression, which may result in:

t=A(xy²+1/3X³)+Bx²+Cxy+Dx+E+F(y)+F1(x,y)x⁴+F2(y)x³y+F3(y)x²y²+F4(y)xy³ [8]

This may be functionally identical to Alvarez, except for the addition of F1, F2, F3 and F4. These additional functions may be shown in this present disclosure to be important for optimized performance.

Designs including rotation: The relative motion perpendicular to the viewing direction may also include rotation in the plane of the lens. In such a scenario, at least one of the lenses may pivot about a pivot location. For a good solution to exist, this must be outside of the lens perimeter.

For the pivot design, we may call r₀0=u, and r−r₀=v, with r₀=1/a. The origin r=O is the pivot point, and r=r0, 8=0 is the point directly in front of the pupil when looking straight ahead. In this form, the equations may be:

r₀⁻¹(r⁻²a³t/a0³+r⁻¹a²t/ara0)1_{(r,0)(r0,0)}=2A [9]

and

r₀⁻¹(a³t/ar²a0)|(r⁻²a²t/a0²)|_{(r,0)=(r0,0)}=0 [10]

And a solution in this form may be:

t=Ar₀[(r²+r₀²)0−2rr₀ sin(0)]+B2r₀r(1−cos(0))+Cr₀[r sin(0)−r₀0}+Dr₀0+E+F(r)+F1 (r,0)r₀⁴0⁴+F2(r)r₀³(r−r₀)0³+F3(r)r₀(r−r₀)0+F4(r)r₀(r−r₀)³0 [11]

The terms have been defined so that the constants are the same as in the general equation, but a shorter equivalent form provided below is possible by redefining the constants:

t˜A′r²0+B′r cos(0)+C′r sin(0)+D′0+E′+F′(r)+F1′(r,0)0⁴+F2′(r)(r−r₀)0³+F3′(r)(r−r₀)²0²+F4′(r)(r−r₀)³0 [12]

### Choosing Parameters

The choice of parameters to the general solutions depends on desired optical performance, other restrictions such as minimum and maximum thickness and aesthetic and other considerations. These specific optimum solutions use a form much more general than that described by Alvarez. Prior art Applicant picks the parameters and functions to optimize lens properties. In some embodiments, specific parameters and functions are optimized to provide desired performance and other quality and aesthetic results.

In some embodiments, the thickness parameters of the lens apparatus constructed by the novel method disclosed herein may be determined in a three part manner. Both the formula described by Alvarez and further developed in U.S. Pat. No. 7,325,922 may be a foundation of a new formula required to incorporate the added fluid refraction and volume used to create the optical focal power.

By adding volumetric function represented by an ellipsoid in the volume formula for:

v=(4/3)pi r1 r2 r3 [13]

and having a surface area equal to:

2×π×[c²+(b×c²)/(√(a²−c²))×F(φ,k)+b×√(a²−c²)×E(φ,k)] [14]

and then a refractive index of the fluid used of

n=c/v [15]

wherein n represents the type of fluid used.

Note, equations [8] through [15] may be unique to this disclosure.

Using the fundamental elements of prior art variable focus lens described in U.S. Pat. No. 6,040,947, wherein a flexible membrane is made to distort to required curvature within a fluid with a front or outer curved lens and combining them with the novel methods described in U.S. Pat. No. 7,325,922, describing two or more lens working in tandem to create an optical axis that can be adjusted through the positioning of disparate lens surfaces that complement each other. Some embodiments, may combine the best practices of both forms of variable focus spectacles into one novel method that may allow for improved efficiencies not realized by the prior art.

Through the use of embossing and other thin film shaping techniques front and rear lens base/foundation surfaces (e.g., the plano or preexisting lens) may be shaped into partial refractive index portions of an overall lens apparatus that continues to provide a thin edge profile that is stylish and flexible, yet continues to exhibit the impact and scratch resistance inherent in prior art polycarbonate lenses currently in wide use for spectacle manufacturing.

In some embodiments, a multilayered spectacle lens may be constructed by this current disclosure taught herein, that may allow adhesive decal-like lens additive thin film sub-lenses to be assembled in unique and optical power preset layers that when combined become one lens of a differing optical power. Multiple layers of different and predetermined focal refractive design may be combined together to create desired refraction and/or optical properties in the full spectrum of −6 diopters to +6 diopters optical power values and lens focal optical power value in between.

Using the novel method described herein and the adhesive optical decal lenses, preexisting eyewear may be retained for continued and proper corrective vision use, even after the focal optical power of the preexisting eyewear without the adhesive optical decal lenses is no longer sufficient to provide the necessary ability for the wearer to see properly. This is accomplished because the adhesive optical decal lens made using the novel methods disclosed herein, may allow the wearer to simply press or attach the adhesive optical decal lens to the existing eyeglass lens, of any optical power setting and thereby modify the optical power of the preexisting lens with the appropriate additive adhesive optical decal lens.

By adding sequentially varied optical power sub-lenses (i.e., the adhesive optical decal lenses) one atop the other by adhering them together, the final lens apparatus may allow used (preexisting) lenses that no longer have the optical power corrective or magnifying properties needed by the wearer, to be reconditioned to a new and appropriately suitable optical power value; and done so easily, efficiently, and cost effectively to both the manufacturer and the wearer.

In some embodiments, fixed focal optical power lenses may be embossed into the polycarbonate substrate currently in use for spectacle lens eyewear. A thinner lens profile of the final lens apparatus is possible, due to the novel multilayered method incorporated in this embodiment. A front face of a plano or magnifying or corrective polycarbonate lens embedded in the eyeglass frame is used as the equivalent thickness evident in current lenses. The front face adhesive optical decal lens and/or the rear face adhesive optical decal lens of some embodiments, may therefore be made extremely thin due to the additive nature of the three or more layers that comprise the full (final) lens apparatus.

Rather than creating one full dimensional apparatus that contains the required thickness of substrate needed to create the refractive index values that will provide the corrective or magnifying optical power of the spectacle desired; a base/foundation lens (i.e., the plano or preexisting lens) serves as a platform that may provide the substrate and the flexibility to create any needed optical power final lens apparatus, by simply applying adhesive optical decal lenses to the front and/or the back (rear) the base/foundation lens.

By creating a system of pre-designed and predetermined lens blanks of base magnification or corrective optical power values; i.e., the base/foundation lenses; and then creating the additive adhesive optical decals lenses, the entire breadth of needed optical power spectacles may be designed and generated, as either an originating lens creation system that replaces and competes favorably with current lens creation techniques; or as an aftermarket method to enhance sunglasses, older spectacles or any eyewear that needs enhanced or changed optical power values.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

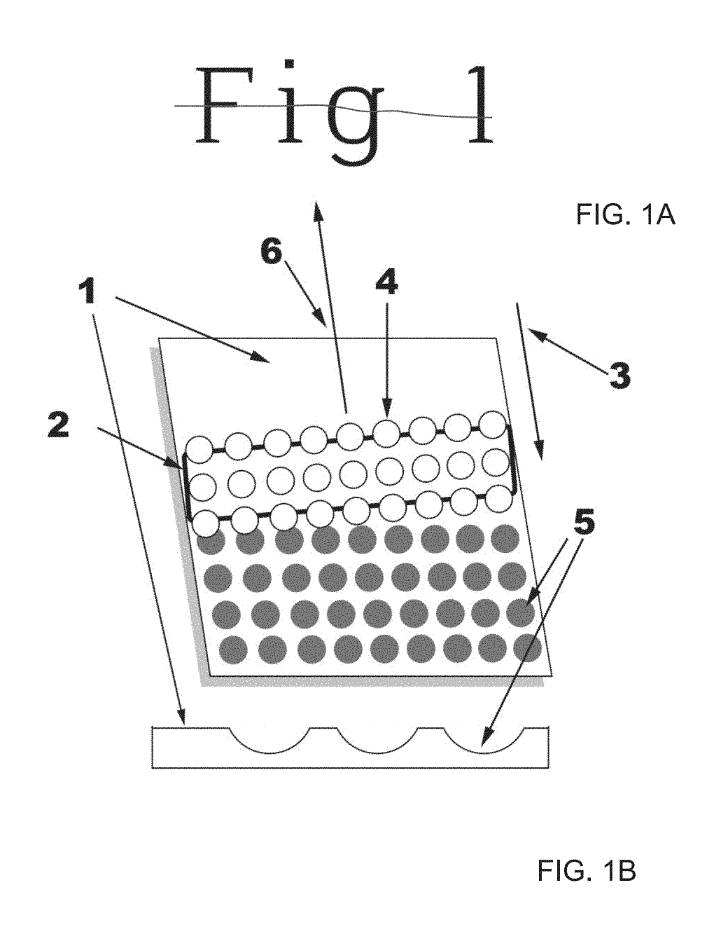

FIG. 1A is a top view of an embossing receiving plate, with a thin film polycarbonate transparent sheet or roll; wherein embossing roller 2 is rolling over a surface 1 of the plate and of the thin film, yielding embossed indented 5 adhesive optical decal lens.

FIG. 1B is a cross-section side view of FIG. 1A, showing indentations 5 of the adhesive optical decal lens.

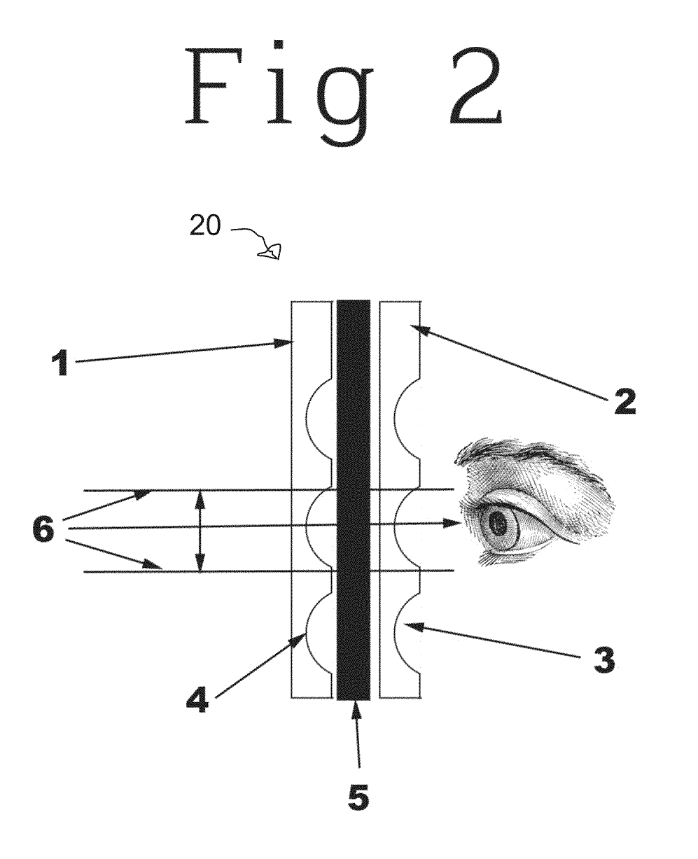

FIG. 2 is a side schematic view of a final lens apparatus 20; wherein the final lens apparatus 20 may comprise a front adhesive optical decal lens 1, a base/foundation lens 5, and a rear adhesive optical decal lens 2. In some embodiments, base/foundation lens 5 may be disposed between front adhesive optical decal lens 1 and rear adhesive optical decal lens 2. In some embodiments base/foundation lens 5 may be one or more of: the plano, preexisting lens, flexible, plastic, transparent, and/or fluid filled. In some embodiments, front adhesive optical decal lens 1 may be transparent. In some embodiments, rear adhesive optical decal lens 2 may be transparent.

Continuing discussing, FIG. 2, in some embodiments, front adhesive optical decal lens 1, rear adhesive optical decal lens 2, base/foundation lens 5, and final lens apparatus 20 may each have their own and differing predetermined refractive and/or optical properties. The refractive and/or optical properties of final lens apparatus 20 may substantially match a prescription for the wearer.

Continuing discussing FIG. 2, while FIG. 2 may only show one front adhesive optical decal lens 1 and one rear adhesive optical decal lens 2; in some embodiments a finite and predetermined quantity of additional adhesive optical decal lenses, each with their own refractive and/or optical properties, may be attached to front adhesive optical decal lens 1 and/or rear adhesive optical decal lens 2, to yield a further multilayered final lens apparatus 20.

Continuing discussing FIG. 2, while FIG. 2 may only show one front adhesive optical decal lens 1 and one rear adhesive optical decal lens 2; in some embodiments there may only be one adhesive optical decal lens, and either front adhesive optical decal lens 1 or rear adhesive optical decal lens 2 may be absent.

Continuing discussing FIG. 2, in some embodiments, front adhesive optical decal lens 1 and/or rear adhesive optical decal lens 2 may be removable or permanent.

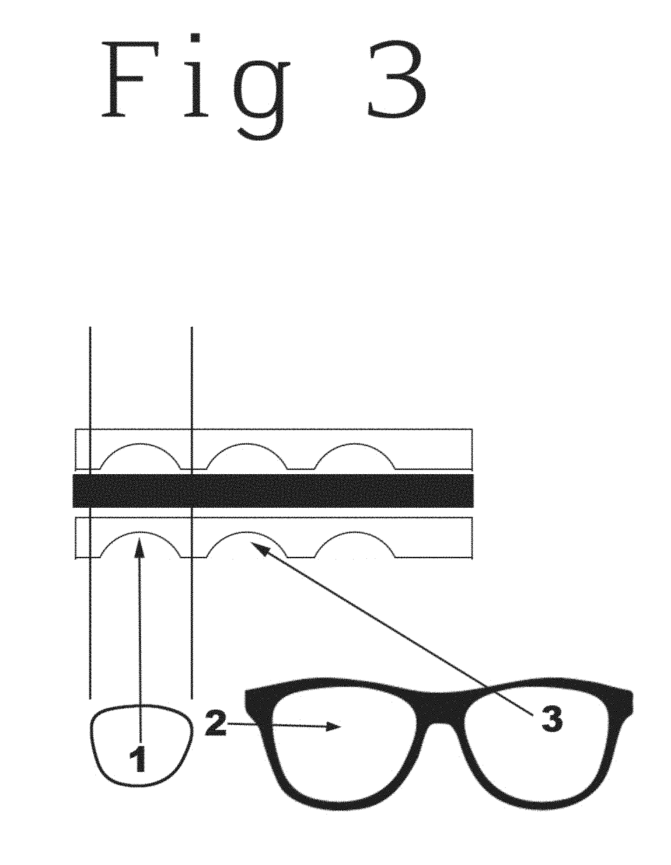

FIG. 3 may show final lens apparatus 20 of FIG. 2 with an added eyeglass frame depiction, to illustrate the embossing process of FIG. 1, may yield a shape of final lens apparatus 20, that is shaped to fit the eyeglass frame upon embossing.

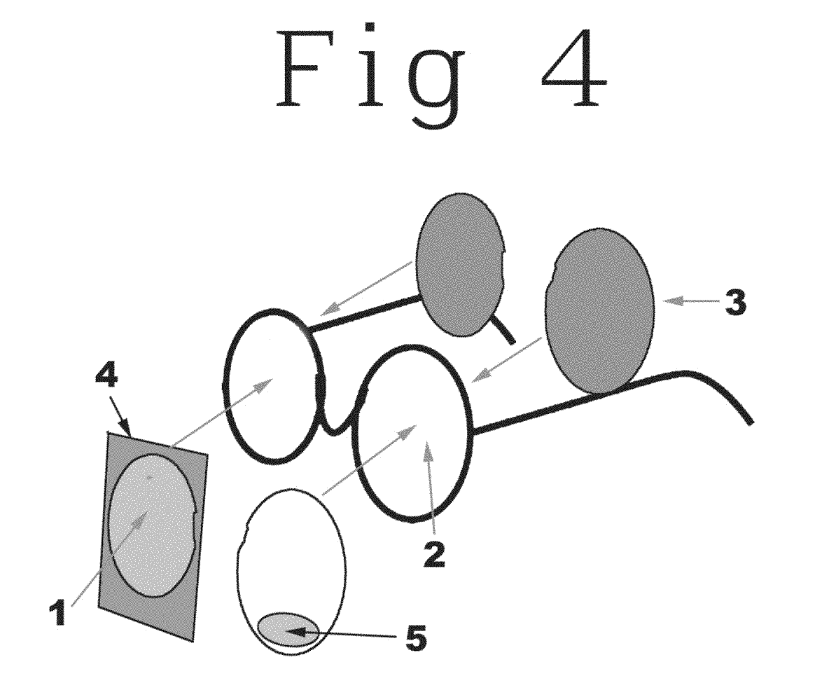

FIG. 4 may show an exploded view of a final lens apparatus, that for the lens base/foundation may utilized preexisting lenses 2; wherein a front adhesive optical decal lens 1 may be attached to a front face of preexisting lens 2; wherein a rear adhesive optical decal lens 3 may be attached to a rear face of preexisting lens 2; and wherein smaller adhesive optical decal lens 5 may be attached to preexisting lens 2 to generate a bi-focal or magnifying configuration for the final lens apparatus. In some embodiments, smaller adhesive optical decal lens 5 may be attached to front adhesive optical decal lens 1, rear adhesive optical decal lens 3, the front of preexisting lens 2, and/or the rear of preexisting lens 2. In some embodiments, smaller adhesive optical decal lens 5 may be smaller than front adhesive optical decal lens 1, preexisting lens 2, or rear adhesive optical decal lens 3. In some embodiments, front adhesive optical decal lens 1, rear adhesive optical decal lens 3, and/or smaller adhesive optical decal lens 5 may be permanent or removable.

In FIG. 4 a small sub-lens decal (smaller adhesive optical decal lens 5) with magnification properties ranging in optical power values from +0.5 to +8 may be achieved while still maintaining the thin lens profile many eyewear users prefer. In this embodiment the base lens (preexisting lens 2) may be additive to smaller adhesive optical decal lens 5 and rear adhesive optical decal lens 3. Each added decal sub-lens (e.g., front adhesive optical decal lens 1, rear adhesive optical decal lens 3, and smaller adhesive optical decal lens 5) may add optical power to the final (overall) lens apparatus.

Continuing discussing FIG. 4, in some embodiments, smaller adhesive optical decal lens 5 is created and affixed, to provide sunglasses or other corrective or magnifying eyewear lenses the ability to enhance the optical power values of a specific area, generally in the lower quadrant, of the eyeglass or spectacle eyewear. This embodiment addresses a specific need in the marketplace wherein current solutions for reading glasses used by persons needing additional magnification if indicia is of smaller text point values. Individuals currently are required to either have a separate additional spectacle or use bifocal glasses or such unwieldly solution.

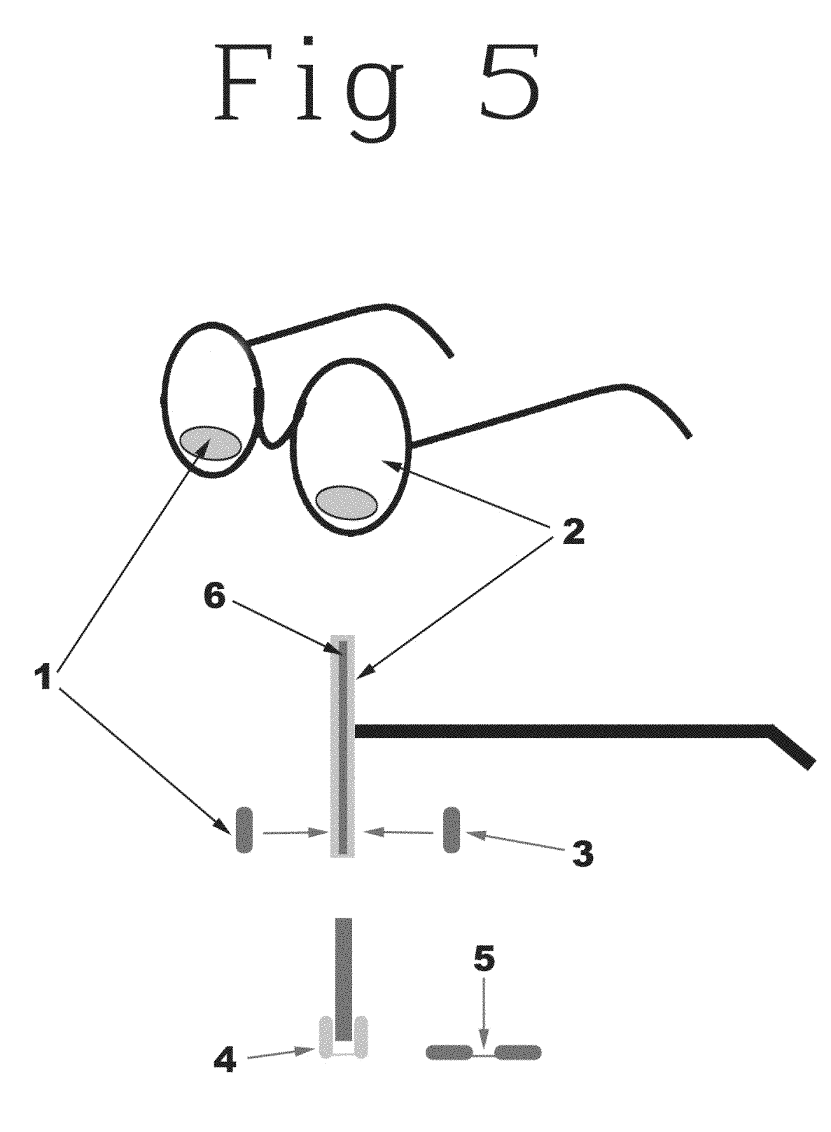

FIG. 5 may show a final lens apparatus embodiment, utilizing preexisting eyeglasses, with preexisting lens 6, with adhesive optical decal lens 2 attached to preexisting lens 6, and with smaller adhesive optical decal lens 1 and/or smaller adhesive optical decal lens 3 attached to adhesive optical decal lens 2. In some embodiments, smaller adhesive optical decal lens 1 and smaller adhesive optical decal lens 3 may be smaller than adhesive optical decal lens 2 and smaller than preexisting lens 6. In some embodiments, use of the smaller adhesive optical decal lens 1 and/or smaller adhesive optical decal lens 3 in the final lens apparatus of FIG. 5 may provide for a bi-focal like configuration. In some embodiments, smaller adhesive optical decal lens 1, adhesive optical decal lens 2, and/or smaller adhesive optical decal lens 3 may be removable or permanent.

FIG. 5 may show a detachable positioning member 5.

As shown in FIG. 5, drawings further establish that a two part sub-lens decal (smaller adhesive optical decal lens 1) is manufactured according to the embossing and/or die cutting methods disclosed herein and then combined with the base plano (preexisting lens 6) and/or corrective or magnifying lens (adhesive optical decal lens 2). In this embodiment, reading glasses may have enhanced optical power decals applied to lower quadrants of the lens providing a second magnifying optical power element to the established existing eyewear lens (preexisting lens 6 and/or adhesive optical decal lens 2). In some embodiments, sunglasses may be converted to reading glasses by adding the sub-lens decal apparatus using the additive process of the present invention to create the desired optical power values. A simple connective tear-away substrate (detachable positioning member 5) may be used to position the decal sub-lenses 4 onto the base eyewear corrective, magnifying or plano lens (preexisting lens 6 and/or adhesive optical decal lens 2) already encased in the eyewear frame. In some embodiments, preexisting lens 6 may be fluid filled with a controlled refractive index, that when combined with the sub-lens apparatus (adhesive optical decal lens 2) may result in the desired optical power values sought for the overall eyewear finished lenses.

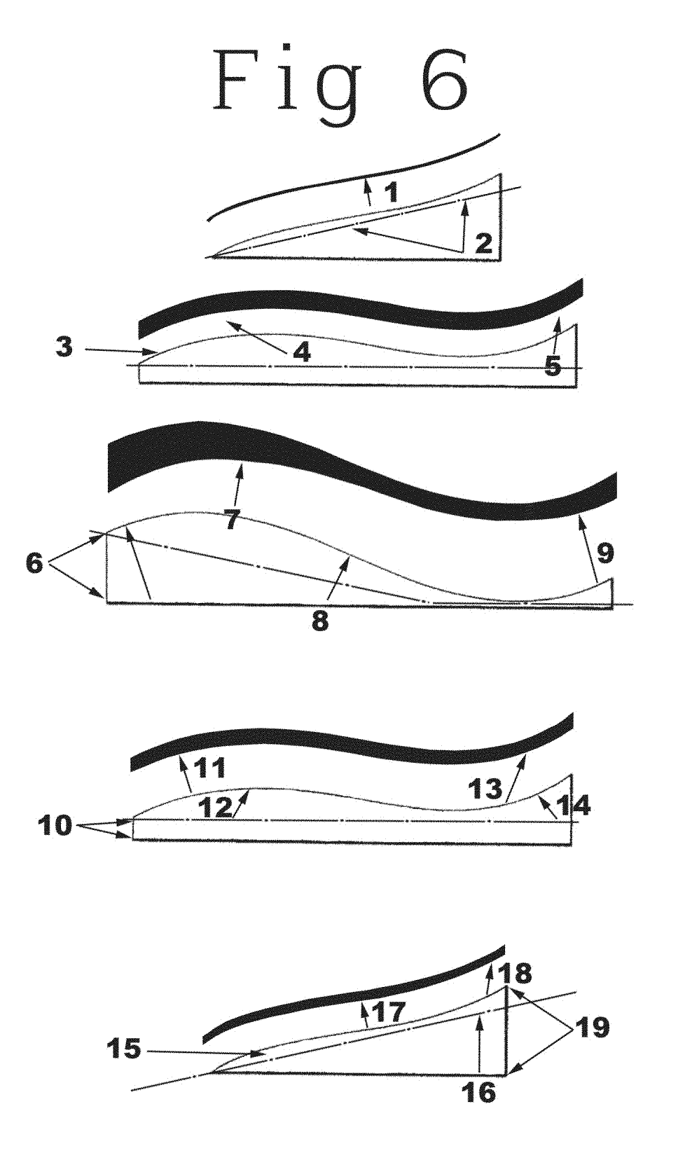

FIG. 6 (1)(3)(7)(11)(15) show a side view of various thin layer iterations of the lens curvatures disclosed in U.S. Pat. No. 3,507,565. Embodiments of the present invention may provide for thinner lens profiles, with base lenses providing the required additional refraction thickness through additive build-up of varied lens configurations that comprise the final combined refractive properties of the final lens apparatus disclosed herein.

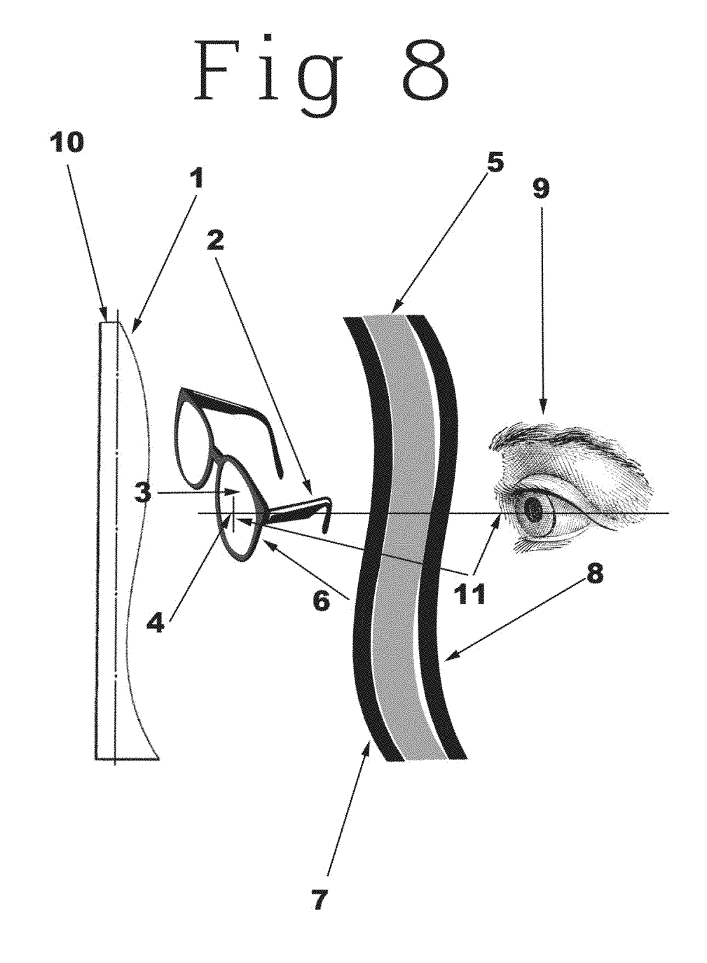

FIG. 8 (10)(1)(7)(8) show a side view of a lens apparatus designed using the techniques disclosed by U.S. Pat. No. 3,507,565 with the novel thin film additive optical decal system of the instant invention. In some embodiments, base lens 5 may be disposed between adhesive optical decal lens 7 and adhesive optical decal lens 8 to form a final lens apparatus. In some embodiments, base lens 5 may be fluid filled. In some embodiments, base lens 5 may be a preexisting lens.

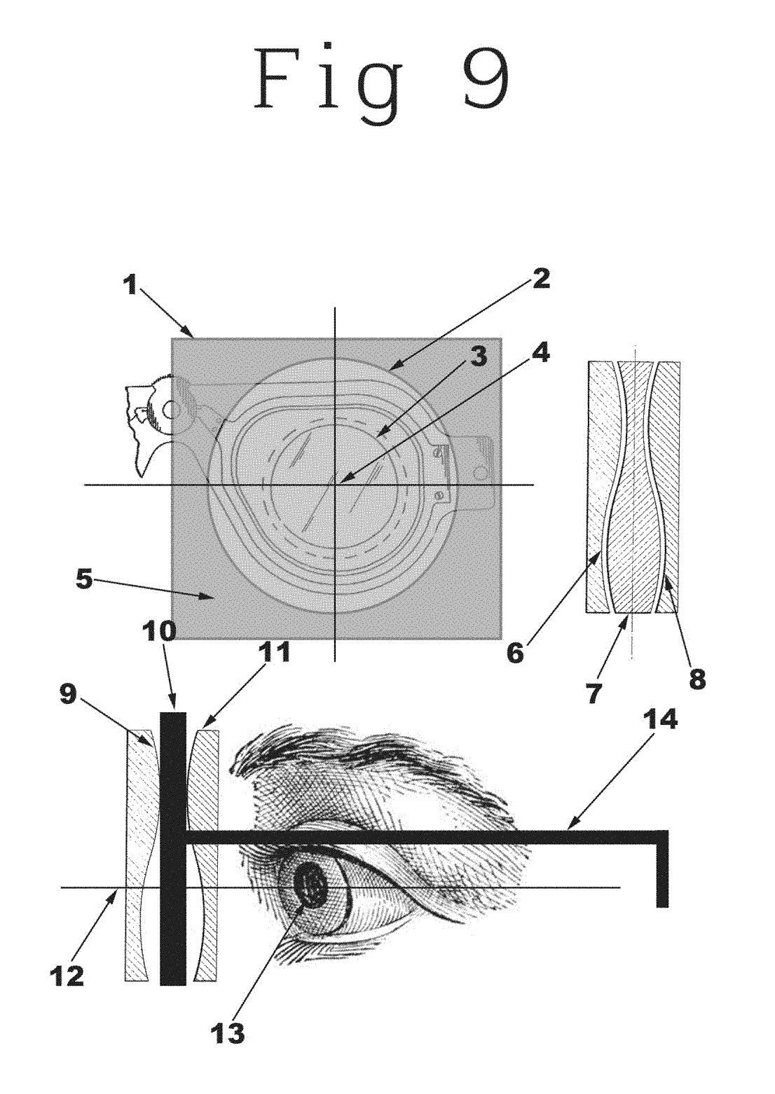

FIG. 9 (1)(3)(10)(9)(11)(6)(7)(8) shows the corrective or magnifying lens disclosed in U.S. Pat. No. 6,040,947 as embodied in the present invention. The flexible membrane is positioned in a fixed state and then a decal is created that is larger than the eyewear base lens. Then a front facing sub-lens apparatus and a rear face sub-lens apparatus is attached to a base lens apparatus wherein the combined refractive indexes of all three units create one optical focal value. This embodiment provides a thinner eyewear profile and allows for re-application of differing optical power values as the wearer's eyesight degrades.

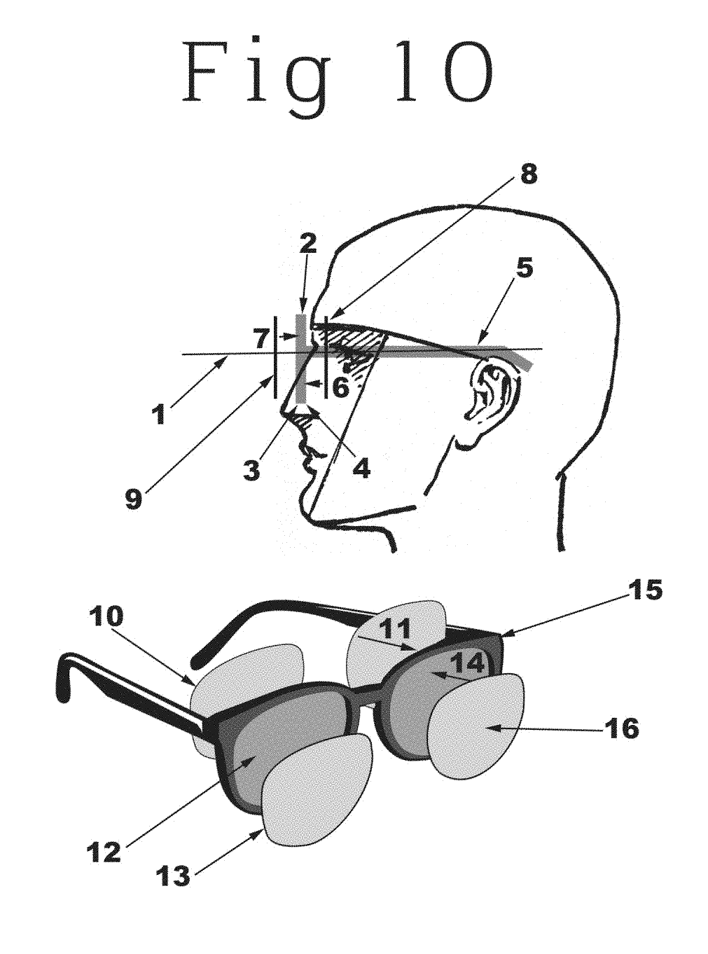

FIG. 10 may show sub-lens decal assemblies 13, 16, 11, and 10 as they would interlay with the base lens 2 and base lens 14 of an eyeglass or spectacle frame 5.

In some embodiments, a lens apparatus (e.g., final lens apparatus 20 of FIG. 2) for correcting vision or for magnifying may comprise, a base lens, with first predetermined optical properties; at least one adhesive optical decal lens, each with its own predetermined optical properties; wherein the at least one adhesive optical decal lens may be attached to the base lens forming the lens apparatus; and wherein the lens apparatus may have third predetermined optical properties. See e.g., FIG. 2, FIG. 3, FIG. 4, FIG. 5, FIG. 8, and FIG. 10.

In some embodiments of the lens apparatus, the base lens may be thicker than the at least one adhesive optical decal lens. See e.g., FIG. 8.

In some embodiments of the lens apparatus, the at least one adhesive optical decal lens may be attached to the base lens at: a front face, a rear face, or the front face and the rear face. See e.g., FIG. 2, FIG. 3, FIG. 4, FIG. 5, FIG. 8, and FIG. 10.

In some embodiments of the lens apparatus, the at least one adhesive optical decal lens may comprise at least a front adhesive optical decal lens and a rear adhesive optical decal lens; wherein the base lens may be disposed between the front adhesive optical decal lens and the rear adhesive optical decal lens, with the front adhesive optical decal lens attached to a front of the base lens, and the rear adhesive optical decal lens attached to a rear of the base lens. See e.g., FIG. 2, FIG. 3, FIG. 4, FIG. 5, FIG. 8, and FIG. 10.

In some embodiments of the lens apparatus, the at least one adhesive optical decal lens may be substantially constructed from one or more of: a thin film or polycarbonate.

In some embodiments of the lens apparatus, a shape of the at least one adhesive optical decal lens may be made by one or more of: embossing or die cutting. See e.g., FIG. 1.

In some embodiments of the lens apparatus, the at least one adhesive optical decal lens may be removable or permanent, with respect to the base lens and/or other adhesive optical decal lenses.

In some embodiments of the lens apparatus, the at least one adhesive optical decal lens may be smaller than the base lens and located on a lower quadrant of the base lens, resulting in a bi-focal functionality for the apparatus. See e.g., FIG. 4 and FIG. 5.

In some embodiments of the lens apparatus, the lens apparatus further may comprise another adhesive optical decal lens, with its own predetermined optical properties; wherein this other adhesive optical decal lens may be attached to the at least one adhesive optical decal lens. See e.g., FIG. 4, FIG. 5, and FIG. 10. In some embodiments of the lens apparatus, the other adhesive optical decal lens may be smaller than the at least one adhesive optical decal lens and located on a lower quadrant of the at least one adhesive optical decal lens, resulting in a bi-focal functionality for the apparatus. See e.g., FIG. 4 and FIG. 5.

In some embodiments of the lens apparatus, the lens apparatus may be fitted to and attached to a lens opening in an eyeglass frame. See e.g., FIG. 3, FIG. 4, FIG. 5, FIG. 8, FIG. 9, and FIG. 10.

In some embodiments of the lens apparatus, the third predetermined optical properties provides vision correction substantially in accordance with a prescription.

In some embodiments of the lens apparatus, the base lens may be one or more of: transparent, flexible, plastic, polycarbonate, a plano, a preexisting lens, fluid filled, and/or the like.

In some embodiments of the lens apparatus, the base lens may be made by one or more of: embossing, die cutting, stamping, extrusion with sectional cutting, injection molding, 3D printing, and/or the like.

In some embodiments of the lens apparatus, the first predetermined optical properties; the predetermined optical properties of the at least one adhesive optical decal lens; and the third predetermined optical properties all differ from each other.

In some embodiments, a lens apparatus may comprise of one or more convex and/or contoured surfaces (e.g., specifically shaped discs and/or films); wherein each surface may have its own predetermined thickness, front and rear facing curvatures; wherein the totality of the one or more convex or contoured surfaces forms the lens apparatus; wherein the lens apparatus may have its own predetermined optical power, refractive, and/or optical properties that may be predetermined and desired. In some embodiments, the totality of the one or more convex or contoured surfaces may form the lens apparatus by the totality of the one or more convex or contoured surfaces stacking with respect to each other in a multilayer manner. In some embodiments, the lens apparatus may also be characterized as a lens array comprised of a plurality (e.g., two or more) of convex or contoured surfaces.

In some embodiments, the one or more convex and/or contoured surfaces, that may form the lens apparatus, may comprise optically transparent adhesive(s), on the front, the rear, or both the front and the rear of the convex or contoured surfaces.

In some embodiments, the one or more convex and/or contoured surfaces, that may form the lens apparatus, may be manufactured via high speed embossing, stamping, and/or cutting (e.g., die and/or laser) from thin film substrates. In some embodiments, the thin film substrates may be a plastic, a thermoplastic, an elastomer, and/or the like. For example and without limiting the scope of the present invention, in some embodiments, the thin film substrates may be substantially polycarbonate and/or silicone; plus with optically transparent adhesive in some embodiments.

In some embodiments, the lens apparatus may comprise the one or more convex and/or contour surfaces may have thickness, front curvature, and/or rear curvature characteristics according to equations in Alavrez U.S. Pat. No. 3,507,565 and U.S. Pat. No. 7,325,922; and/or according subsequent mathematical geometry, some of which is noted herein.

In some embodiments, each layer, i.e., each convex and/or contour surface, may have its own geometry, with its own closed two dimensional shape (as viewed from the front or the rear), with its own thickness, its own front curvature, and/or its own back (rear) curvature, all to predetermined specifications; wherein a stacking totality of such layers may result in a different geometry for the overall lens apparatus (lens array) with different and predetermined refractive and optical properties, that may be substantially in accord with a prescription or wearer's corrective or magnifying vision needs. Thus, each layer may refract light differently, but predictably, from each other. The overall lens apparatus (lens array) have a desired optical diopter from this multilayer of convex and/or contour surfaces.

In some embodiments, the one or more convex and/or contoured surfaces may be the adhesive optical decals lens. In some embodiments, the lens apparatus that may comprise of one or more convex or contoured surfaces; may also comprise a plano lens, wherein at least one of the one or more convey or contoured surfaces may be adhered to this plano. In some embodiments, a convex and/or contoured surface may be adhered to the front, the rear, and/or both the front and the rear of the plano. In some embodiments, the convex and/or contoured surface adhered to the front of the plano may have different refractive and optical properties as compared against the convex and/or contoured surface adhered to the rear of the plano. In some embodiments, the plano, prior to receiving the one or more convex and/or contoured surfaces, may already be affixed to an eyeglass frame.

In some embodiments, manufacturing of the one or more convex and/or contoured surfaces may be done via high speed thermal embossing techniques, stamping techniques, die cutting techniques, and/or laser cutting techniques of thin films; which may output the convex and/or contoured surfaces, with their predetermined geometries and associated predetermined refractive and optical properties. For example, and without limiting the scope of the present invention, in some embodiments, resulting multilayered lens arrays may have one diopter lens optical power value or other optical power values commonly produced in the industry.

In some embodiments, a wearer of eyeglasses may select from a plurality of convex and/or contoured surfaces (e.g., a plurality of adhesive optical decal lenses), each with their own specific refractive and optical properties, place such convex and/or contoured surfaces on the preexisting lens of the eyeglasses to achieved a desired optical power value; which may be subsequently varied by adding and/or removing convex and/or contoured surfaces.

These techniques may generate effective and extremely affordable corrective and/or magnifying eyewear, wherein the optical power values may be readily modified. These techniques are repeatable, reliable, very fast, and very cost effective. These techniques may reduce or eliminate a need to injection mold lens blanks; may reduce or eliminate fine grinding and polishing steps associated with prior art lens manufacturing.

Lens apparatuses (lens arrays), adhesive optical decal lenses, variable focus adhesive optical decals, methods of making, and method of using have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A lens apparatus for correcting vision or for magnifying, comprising
a base lens, with first predetermined optical properties;
at least one adhesive optical decal lens, each with its own predetermined optical properties;
wherein the at least one adhesive optical decal lens is attached to the base lens forming the lens apparatus;
wherein the lens apparatus has third predetermined optical properties.

2. The lens apparatus according to claim 1, wherein the base lens is thicker than the at least one adhesive optical decal lens.

3. The lens apparatus according to claim 1, wherein the at least one adhesive optical decal lens is attached to the base lens at: a front face, a rear face, or the front face and the rear face.

4. The lens apparatus according to claim 1, wherein the at least one adhesive optical decal lens comprises at least a front adhesive optical decal lens and a rear adhesive optical decal lens;
wherein the base lens is disposed between the front adhesive optical decal lens and the rear adhesive optical decal lens, with the front adhesive optical decal lens attached to a front of the base lens, and the rear adhesive optical decal lens attached to a rear of the base lens.

5. The lens apparatus according to claim 1, wherein the at least one adhesive optical decal lens is substantially constructed from one or more of: a thin film or polycarbonate.

6. The lens apparatus according to claim 1, wherein a shape of the at least one adhesive optical decal lens is made by one or more of: embossing or die cutting.

7. The lens apparatus according to claim 1, wherein the at least one adhesive optical decal lens is removable or permanent.

8. The lens apparatus according to claim 1, wherein the at least one adhesive optical decal lens is smaller than the base lens and located on a lower quadrant of the base lens, resulting in a bi-focal functionality for the apparatus.

9. The lens apparatus according to claim 1, wherein the lens apparatus further comprise another adhesive optical decal lens, with its own predetermined optical properties; wherein the other adhesive optical decal lens is attached to the at least one adhesive optical decal lens.

10. The lens apparatus according to claim 9, wherein the other adhesive optical decal lens is smaller than the at least one adhesive optical decal lens and located on a lower quadrant of the at least one adhesive optical decal lens, resulting in a bi-focal functionality for the apparatus.

11. The lens apparatus according to claim 1, wherein the lens apparatus is fitted to and attached to a lens opening in an eyeglass frame.

12. The lens apparatus according to claim 1, wherein the third predetermined optical properties provides vision correction substantially in accordance with a prescription.

13. The lens apparatus according to claim 1, wherein the base lens is one or more of: transparent, flexible, plastic, polycarbonate, a plano, a preexisting lens, or fluid filled.

14. The lens apparatus according to claim 1, wherein base lens is made by one or more of: embossing, die cutting, stamping, extrusion, or injection molding.

15. The lens apparatus according to claim 1, wherein the first predetermined optical properties; the predetermined optical properties of the at least one adhesive optical decal lens; and the third predetermined optical properties all differ from each other.

16. A lens apparatus with at least one adhesive optical decal lens as shown and described herein.

17. A method for making lens apparatus as shown and described herein.
